(19) United States
(12) Patent Application Publication
(10) Pub. No.: US 2015/0196845 A1
(43) Pub. Date: Jul. 16, 2015

(54) METHOD AND SYSTEM FOR PROVIDING SOCIAL GAME USE WITH FINANCIAL CARD TRANSACTIONS

(71) Applicant: MasterCard International Incorporated, Purchase, NY (US)

(72) Inventors: David Klemm, Griesheim (DE); Purvi Jatin Gandhi, Bad Homburg (DE); Stefania Del Tosto, Rome (IT); Michael J. Cowen, London (GB); Vladimir Rymchuk, Kyiv (UA); Bensam Joyson, Singapore (SG); Stephen Elder, Dublin (IE); James Gallagher, Dublin (IE)

(73) Assignee: MasterCard International Incorporated, Purchase, NY (US)

(21) Appl. No.: 14/152,225

(22) Filed: Jan. 10, 2014

(51) Int. Cl. A63F 13/792; G06Q 30/02; A63F 13/73; G06Q 20/40

(52) U.S. Cl. CPC A63F 13/792; G06Q 20/40; G06Q 30/0269; A63F 13/73

(57) ABSTRACT

A method for scoring a payment transaction includes: storing consumer profiles, each consumer profile including a consumer identifier, contact information, and team identifier; storing merchant profiles, each merchant profile including a merchant identifier and plurality of team scores; receiving an authorization request for a payment transaction, the request including a consumer identification, merchant identification, and transaction data; identifying a specific consumer profile where the included consumer identifier corresponds to the consumer identification; identifying a specific merchant profile where the included merchant identifier corresponds to the merchant identification; identifying a transaction score for the transaction using one or more scoring rules based on the transaction data; updating, in the specific merchant profile, a team score corresponding to the team identifier included in the specific consumer profile based on the transaction score; and transmitting a notification to a consumer related to the specific consumer profile based on the included contact information.

### FIELD

The present disclosure relates to the scoring of payment transactions as part of a social game, specifically the use of scoring models to score payment transactions, which are applied to a consumer team at a respective merchant, for example.

### BACKGROUND

Merchants often seek new and unique methods and systems for driving consumers to their stores. Increasing the foot traffic into a store, or web traffic on a website, can often result in an increase in sales, and thus hopefully an increase in profit. A common tactic used by merchants is to provide incentives to a consumer to visit the merchant's store, whether physical or on the Internet. Traditional systems and methods include incentivizing the consumer with offers or discounts, such as by advertising an enticing sale or special offer. Other methods include loyalty programs, which may provide additional discounts and incentives following repeated visits.

In more recent times, some merchants and third party entities have begun utilizing gamification to influence consumers, particularly via applications executed by mobile communication devices carried by consumers. Application programs, such as Foursquare, make a game out of consumers visiting physical locations, including merchant stores. In an effort to further increase consumer traffic, some merchants may work with third parties that provide such applications to provide an additional incentive, such as providing an offer or discount to a consumer that visits their storefront as part of a game.

However, many of these application programs, as well as merchant incentives, operate on a premise that involves pitting individual consumers against other consumers, which discourages cooperation among consumers that could potentially result in the fostering of additional business for a merchant. In addition, many of these programs also rely on consumers confirming their physical presence at a merchant, such as by using their mobile communication device. This not only suffers from the problem that not all consumers may use a suitable mobile communication device, but such devices and/or their required connection to a mobile communication network may be unavailable. Further, such methods may focus on a physical storefront for a merchant and thus be wholly ineffective at increasing traffic to the merchant's website.

Thus, there is a need for a technical solution to provide incentives for consumers to visit a merchant's physical and/or electronic storefronts, while also fostering teamwork among consumers to encourage additional business.

### SUMMARY

The present disclosure provides a description of systems and methods for scoring payment transactions.

A method for scoring a payment transaction includes: storing, in a consumer database, a plurality of consumer profiles, wherein each consumer profile includes data related to a consumer including at least a consumer identifier, contact information, and a team identifier; storing, in a merchant database, a plurality of merchant profiles, wherein each merchant profile includes data related to a merchant including at least a merchant identifier and a plurality of team scores; receiving, by a receiving device, an authorization request for a payment transaction, wherein the authorization request includes at least a consumer identification, a merchant identification, and transaction data; identifying, in the consumer database, a specific consumer profile where the included consumer identifier corresponds to the consumer identification; identifying, in the merchant database, a specific merchant profile where the included merchant identifier corresponds to the merchant identification; identifying, by a processing device, a transaction score for the payment transaction using one or more scoring rules based on the transaction data; updating, in the specific merchant profile, a team score of the plurality of team scores corresponding to the team identifier included in the specific consumer profile based on the transaction score; and transmitting, by a transmitting device, a notification to the consumer related to the specific consumer profile based on the included contact information.

A system for scoring a payment transaction includes a consumer database, a merchant database, a receiving device, a processing device, and a transmitting device. The consumer database is configured to store a plurality of consumer profiles, wherein each consumer profile includes data related to a consumer including at least a consumer identifier, contact information, and a team identifier. The merchant database is configured to store a plurality of merchant profiles, wherein each merchant profile includes data related to a merchant including at least a merchant identifier and a plurality of team scores. The receiving device is configured to receive an authorization request for a payment transaction, wherein the authorization request includes at least a consumer identification, a merchant identification, and transaction data. The processing device is configured to: identify, in the consumer database, a specific consumer profile where the included consumer identifier corresponds to the consumer identification; identify, in the merchant database, a specific merchant profile where the included merchant identifier corresponds to the merchant identification; identify a transaction score for the payment transaction using one or more scoring rules based on the transaction data; and update, in the specific merchant profile, a team score of the plurality of team scores corresponding to the team identifier included in the specific consumer profile based on the transaction score. The transmitting device is configured to transmit a notification to the consumer related to the specific consumer profile based on the included contact information.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for scoring payment transactions for a team of consumers at a merchant in accordance with exemplary embodiments.

FIG. 2 is a block diagram illustrating the processing server of FIG. 1 for the scoring of payment transaction and subsequent generation of team scores for a merchant in accordance with exemplary embodiments.

FIG. 3 is a flow chart illustrating a method scoring a payment transaction and subsequently updating a corresponding team score at a merchant in accordance with exemplary embodiments.

FIGS. 4A and 4B are a flow diagram illustrating a process for scoring a payment transaction using the system of FIG. 1 in accordance with exemplary embodiments.

FIGS. 5A-5D are diagrams illustrating a graphical user interface for the mobile device of FIG. 1 for the incentivizing of consumer activities through the scoring of payment transactions in accordance with exemplary embodiments.

FIG. 6 is a flow chart illustrating an exemplary method for scoring a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Scoring Payment Transactions

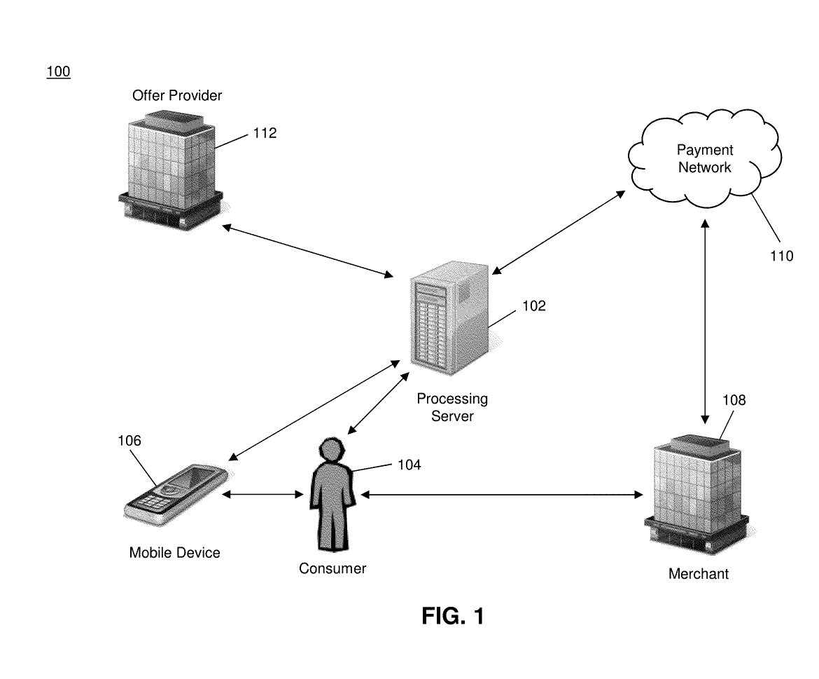

FIG. 1 illustrates a system 100 for the scoring of payment transactions and the generating and updating of team scores at a merchant.

The system 100 may include a processing server 102. The processing server 102, discussed in more detail below, may be configured to operate a service for scoring payment transactions. The processing server 102 may first register a consumer 104. The consumer 104 may provide registration information in order to register with the transaction scoring service, including selecting a team of consumers. In some embodiments, the consumer 104 may be presented with a limited selection of teams.

Teams may be separated arbitrarily, each may be associated with a particular group of consumers, such as based on one or more demographics (e.g., age, gender, income, residential status, familial status, education, occupation, location, etc.), or consumers may request to be part of a form a specific group, such as a group of friends forming their own team. For example, the consumer 104 may be requested to select between a first team associated with consumers interested in fashion trends, a second team associated with consumers interested in entertainment, and a third team associated with consumers interested in family activities. Additional criteria for the creation and separation of teams will be apparent to persons having skill in the relevant art.

In some embodiments, the consumer 104 may register with the processing server 102 via a computing device, such as a mobile device 106 or any other computing device suitable for performing the functions as disclosed herein as will be apparent to persons having skill in the relevant art. The mobile device 106 may be any type of mobile communication device suitable for performing the functions disclosed herein, such as a cellular phone, smart phone, laptop computer, tablet computer, etc. The consumer 104 may register with the transaction scoring service offered by the processing server 102 via an application program executed by the mobile device 106, such as a web browsing program or a standalone application program developed by and/or on behalf of the processing server 102.

After the consumer 104 has registered with the processing server 102 and selected (e.g., or been assigned to) a team, the processing server 102 may generate and store consumer profile associated with the consumer 104, as discussed in more detail below. The consumer 104 may then visit a merchant 108 (e.g., either at a physical store or electronically, such as via an Internet webpage). The consumer 104 may conduct a payment transaction with the merchant 108 for the purchase of goods or services.

The payment transaction may be processed by a payment network 110. Systems and methods for processing a payment transaction will be apparent to persons having skill in the relevant art, such as the systems and methods discussed above. As part of, or following the processing of the payment transaction, the payment network 110 may transmit the authorization request and/or the transaction data included therein for the payment transaction involving the consumer 104 and merchant 108 to the processing server 102.

The processing server 102 may receive the authorization request and may identify a consumer profile associated with the consumer 102 and a merchant profile associated with the merchant 108 based on data included therein, as discussed in more detail below. The processing server 102 may then score the payment transaction based on one or more scoring rules. The scoring rules may be used to score the payment transaction based on various criteria including the transaction amount, the merchant 108, the consumer 104, the team to which the consumer 104 belongs, a rank of the team to which the consumer 104 belongs, a category or industry of the merchant 108, a geographic location of the consumer 104 and/or the merchant 108, the time and/or date when the transaction was conducted, and any other suitable criteria as will be apparent to persons having skill in the relevant art.

The processing server 102 may then update a team score for the team of the consumer 104 in the merchant profile associated with the merchant 108. In some embodiments, the processing server 102 may also update a score associated with the individual consumer 104 in the corresponding consumer profile and/or an overall score for the team in a corresponding team profile. The processing server 102 may be configured to provide a notification to the consumer 104 of the successful scoring of the payment transaction. Information included in the notification and the method of distribution to the client thereof may be selected by the consumer 104, which may be stored in the corresponding consumer profile. In some instances, the processing server 102 may be further configured to provide offers (e.g., deals, discounts, coupons, etc.) to the consumer 104.

The processing server 102 may receive one or more offers for distribution from a third party, such as an offer provider 112, the merchant 108, etc. The processing server 102 may store the offers in an offer database, as discussed in more detail below. Each offer may include offer criteria for the distribution of the respective offer. For example, offers may be distributed based on a team's rank at the merchant 108, a team's points at the merchant 108, a team's overall points, a consumer's overall points, a consumer's points at a merchant, a consumer's or team's points at a merchant or overall during a specific period of time, and other suitable criteria as will be apparent to persons having skill in the relevant art.

The processing server 102 may identify available offers for the consumer 104 based on the associated criteria and present them to the consumer 104. In some instances, the processing server 102 may identify the offers for distribution to the consumer 104 following the scoring of a payment transaction involving the consumer 104 or another member on the same team as the consumer 104, such as a transaction that increases the team score to a level for which a new offer is awarded. In other instances, the processing server 102 may identified offers once prompted by the consumer 104, such as via an application program on the mobile device 106. For example, the processing server 102 may identify eligible offers once the consumer 104 visits a corresponding webpage or corresponding display screen on the application program.

The system 100 may provide several advantages over traditional systems. First, by not relying on a geographic location of the consumer 104 or the mobile device 106, the processing server 102 may be able to score payment transactions for transactions that are conducted electronically (e.g., via the Internet) in addition to transactions where the consumer 104 visits the merchant 108 in person, unlike existing systems. Second, by organizing consumers into teams, consumers may work together to inform teammates of recently earned offers or offers that may be earned by additional activity at a merchant. This may, in turn, foster additional business at the merchant 108. Third, consumers may be informed of new merchants or products that they may be interested based on the behavior of their teammates, such as by seeing team hotspots (e.g., popular locations) where the consumer's team is earning points. Depending on the implementation, there may be additional benefits of the systems and methods discussed herein that are possible as will be apparent to persons having skill in the relevant art.

### Processing Device

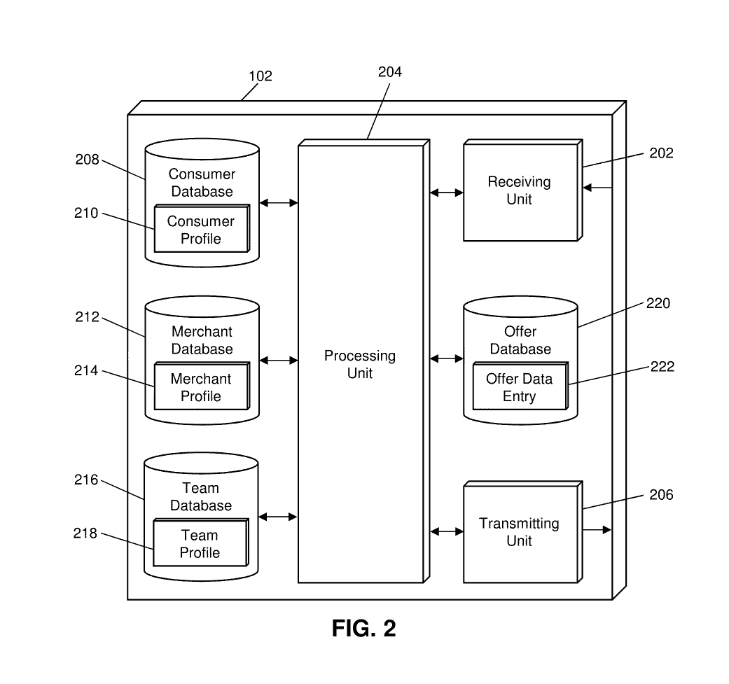

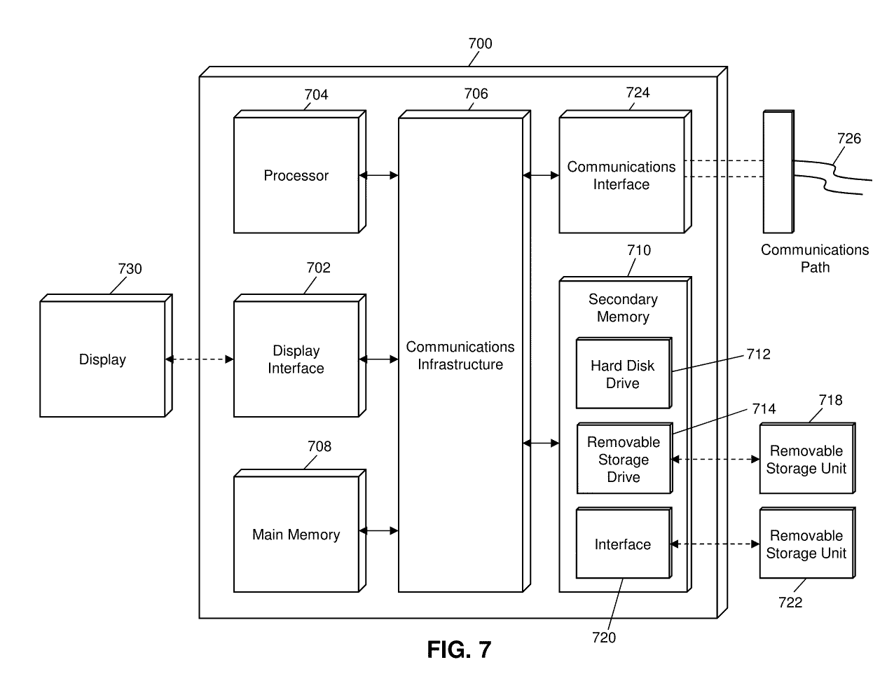

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving unit 202. The receiving unit 202 may be configured to receive data over one or more networks via one or more network protocols. The receiving unit 202 may receive registration information from the consumer 104, such as via the mobile device 106. The registration information may include at least a consumer identifier associated with the consumer 104, contact information, and a team identifier associated with a team selected by the consumer. The processing server 102 may further include a processing unit 204. The processing unit 204 may be configured to generate a consumer profile 210 associated with the consumer 104 including the received registration information, and store the consumer profile 210 in a consumer database 208.

The consumer profile 210 may include at least the consumer identifier, the contact information, and the team identifier. The consumer identifier may be a unique value associated with the consumer 104 for identification of the corresponding consumer profile 210. The consumer identifier may be an identification number, a payment account number (e.g., corresponding to a payment account associated with the consumer 104), an e-mail address, a username, a name, a street address, a phone number, etc. In some instances, the consumer identifier may be a device identifier associated with the mobile device 106 associated with the consumer 104.

The contact information may be a preferred method of contact of the consumer 104 for receiving information from the processing server 102, such as notifications of scored transactions, offer data for eligible offers, etc. Methods of contact between the consumer 104 and the processing server 102 may include e-mail, telephone, short message service message, multimedia message service message, webpage, application program, and other suitable methods that will be apparent to persons having skill in the relevant art. The team identifier may be a unique value associated with a specific team that the consumer 104 wishes to join. The team identifier may be an identification number, name, or other suitable value.

The processing server 102 may further include a merchant database 212. The merchant database 212 may be configured to store a plurality of merchant profiles 214. Each merchant profile 214 may include data related to a merchant 108 and may include at least a merchant identifier and a plurality of team scores. The merchant identifier may be a unique value associated with the related merchant 108 and/or the respective merchant profile 214, such as a merchant identification number (MID). The plurality of team scores may include a team score for each team that the consumer 104 may join. In some instances, each team score may be associated with the team identifier of the respective team for use in identification of the correct respective score. In other instances, each team score may be stored in a data field corresponding to the respective team.

In some embodiments, the processing server 102 may further include a team database 216 configured to store a team profile 218 associated with each team the consumer 104 may join. The team profile 218 may include at least the team identifier associated with the related team. In some embodiments, the team profile 218 may further include an overall transaction score for transactions involving members of the team, a team name, a team description, a team logo, and any other suitable information as will be apparent to persons having skill in the relevant art.

The receiving unit 202 may be further configured to receive an authorization request for a payment transaction from the payment network 110. The authorization request may include a consumer identifier, a merchant identifier, and transaction data. The processing unit 204 may be configured to identify a specific consumer profile 210 in the consumer database 208 where the included consumer identifier corresponds to the consumer identifier included in the authorization request. The processing unit 204 may be further configured to identify a specific merchant profile 214 where the included merchant identifier corresponds to the merchant identifier included in the authorization request.

The processing unit 204 may also be configured to generate a score for the payment transaction based on at least the transaction data and one or more scoring rules. The scoring rules may be stored by the processing unit 204 in a memory of the processing server 102 or received by the receiving unit 202. The processing unit 204 may then update a team score included in the specific merchant profile 214 based on the team of the consumer 104 corresponding to the specific consumer profile 210 based on the included team identifier. The processing unit 204 may also generate a notification based on the scored payment transaction. Information included in the notification, such as the transaction score, total team score, total consumer score, etc. may be based on data that may be included in the specific consumer profile 210.

The processing server 102 may also include a transmitting unit 206. The transmitting unit 206 may be configured to transmit data over one or more networks via one or more network protocols. The transmitting unit 206 may transmit the generated notification to the consumer 104 based on the contact information included in the specific consumer profile 210. In embodiments where the processing server 102 may include the team database 216, the processing unit 204 may be further included to update data stored in the team profile corresponding to the team identifier included in the specific consumer profile 210 based on the generated score and/or the transaction data included in the authorization request for the payment transaction.

In some embodiments, the receiving unit 202 may be further configured to receive offer data corresponding to one or more offers for the purchase of goods or services. The processing unit 204 may be configured to generate an offer data entry 222 for each received offer and store the generated offer data entries 222 in an offer database 220. Each offer data entry 222 may include at least one merchant identifier, each corresponding to a merchant 108 with whom the related offer may be redeemed, offer data, and a target score. The offer data may include at least one of: an offer name, offer description, offer amount, offer type, offer category, merchant type, merchant category, manufacturer information, start date, expiration date, quantity, and limitations on redemption. The target score may be a score (e.g., team score at the merchant 108, overall team score, team score over a predetermined period of time, overall consumer score, etc.) that, once exceeded, may result in eligibility to receive and/or redeem the offer by the exceeding team and/or consumer 104.

The processing unit 204 may be configured to identify when teams and/or consumers (e.g., based on the data included in the respective consumer profiles 210, merchant profiles 214, and/or team profiles 218) exceed target scores included in offer data entries 222. Once eligible offers are identified, the transmitting unit 206 may be configured to transmit offer data for the eligible offers to respective consumers 104 using the contact method included in the respective consumer's associated consumer profile 210.

### Method for Scoring a Payment Transaction

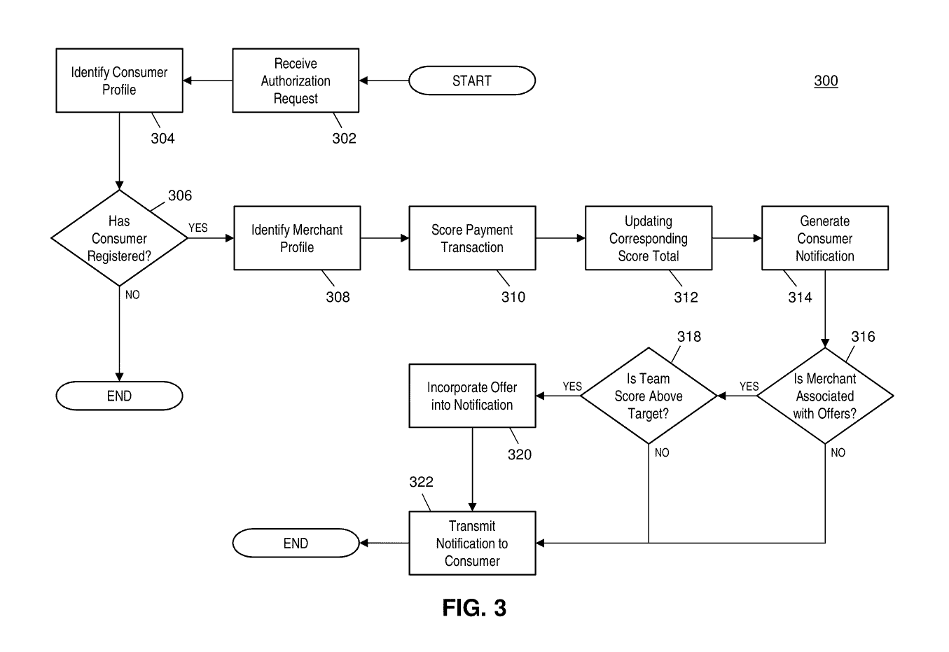

FIG. 3 illustrates a method 300 for the scoring of a payment transaction and subsequent updating of a team score carried out by the processing server 102 of the system 100.

In step 302, the receiving unit 202 of the processing server 102 may receive an authorization request for a payment transaction from the payment network 110. The authorization request may include at least a consumer identifier, merchant identifier, and transaction data. In step 304, the processing unit 204 of the processing server 102 may identify a consumer profile 210 in the consumer database 208 where the included consumer identifier corresponds to the consumer identifier included in the received authorization request. In step 306, the processing unit 204 may determine if the consumer 104 corresponding to the consumer identifier has registered to use the service based on the related consumer profile 210. If the consumer 104 has not registered to use the service, then the method 300 may be completed.

If the consumer 104 has registered with the service, then, in step 308, the processing unit 204 may proceed by identifying a merchant profile 214 in the merchant database 212 where the included merchant identifier corresponds to the merchant identifier included in the received authorization request. In step 310, the processing unit 204 may score the payment transaction based on at least the transaction data and one or more scoring rules. In step 312, the processing unit 204 may update a score total for the corresponding team, based on the team identifier included in the identified consumer profile 210, as included in the identified merchant profile 308. In some embodiments, the processing unit 204 may also update additional scores in the identified consumer profile 210 and/or in a team profile 218 where the included team identifier corresponds to the team identifier included in the identified consumer profile 210.

In step 314, the processing unit 204 may generate a consumer notification to be provided to the consumer 104 and/or the consumer's team. Data included in the notification may be identified by the processing server 102 (e.g., and stored in a memory) and/or may be selected by the consumer 104 and stored in the identified consumer profile 210. In step 316, the processing unit 204 may identify if the merchant 108 corresponding to the identified merchant profile 214 is associated with any offer data entries 222 stored in the offer database 220. The processing unit 204 may determine the merchant 108 to be associated with an offer data entry 222 if the merchant identifier included in the offer data entry 222 corresponds to the merchant identifier included in the corresponding merchant profile 214.

If the merchant 108 is associated with one or more offers, then, in step 318, the processing unit 204 may further determine if the updated score for the team of the consumer 104 is above the target score included in the respective offer data entries 222. If the score is exceeded, then, in step 320, the processing unit 204 may incorporate the offer data for the offers for which the score is exceeded into the notification to be distributed to the consumer 104 and/or the consumer's team. After any eligible offer has been incorporated into the notification, or if the team is not eligible for any offer, or the merchant 108 is not associated with any offers, in step 322 the transmitting unit 206 of the processing server 112 may transmit the notification to the consumer 104 and/or the consumer's team based on the contact information included in the identified consumer profile 210 and/or team profile 218.

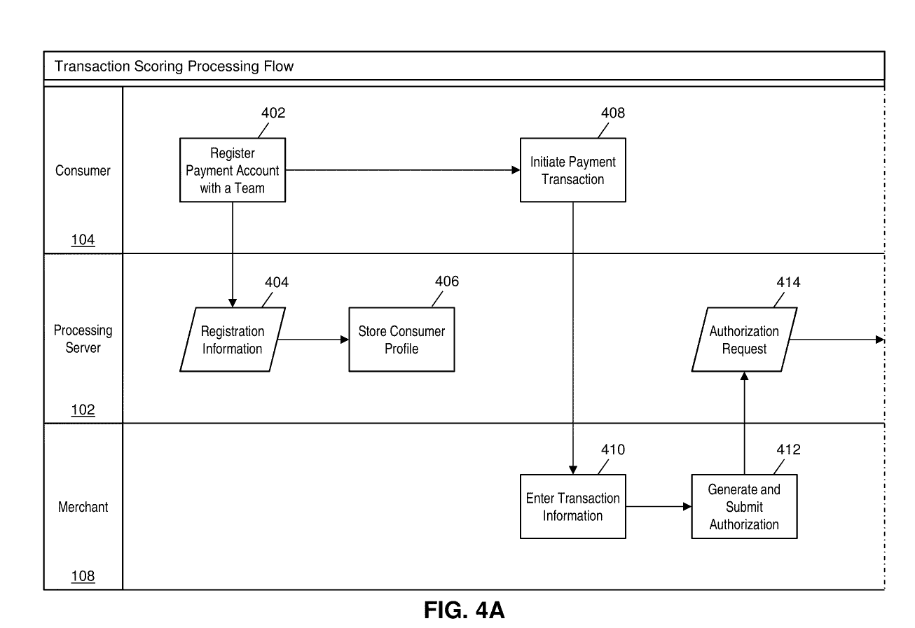

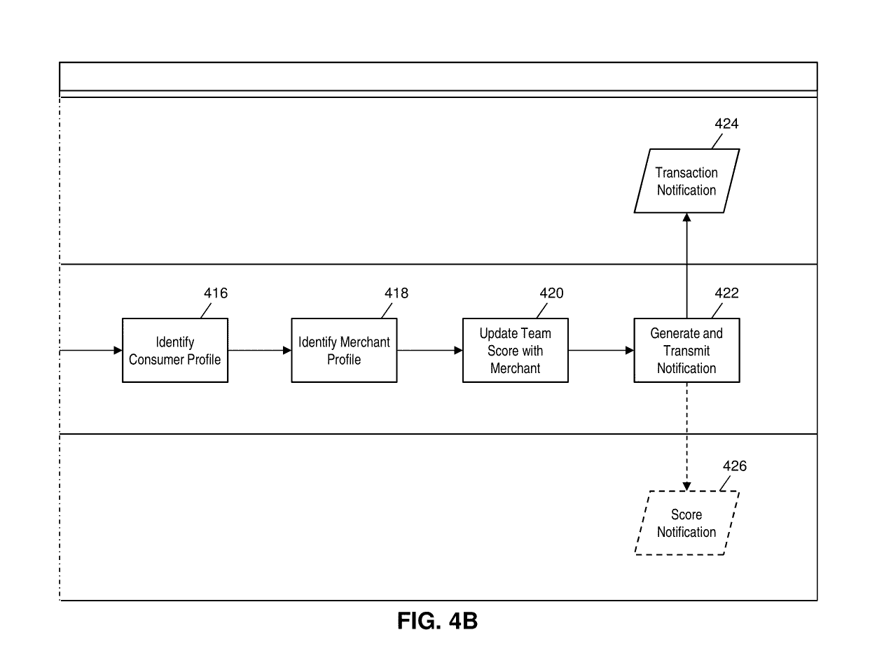

FIGS. 4A and 4B illustrate a processing flow for the scoring of a payment transaction and subsequent updating of a team score using the system 100 of FIG. 1.

In step 402, the consumer 104 may register for the service operated by the processing server 102 by providing a payment account to be registered and by selecting a team. In step 404, the processing server 102 may receive the registration information from the consumer 104, which may also include contact information, which may be obtained via the submission of the registration information (e.g., the contact method may be a website or application program used by the consumer 104 to provide the registration information). In step 406, the processing server 102 may generate and store a consumer profile 210 associated with the consumer 104 and including the registration information in the consumer database 208.

In step 408, the consumer 102 may initiate a payment transaction with the merchant 108 and use the registered payment account to fund the transaction. The payment transaction may be an in-person transaction or a remote transaction (e.g., via the Internet, telephone, mail-order, etc.). In step 410, the merchant 108 may enter the transaction information for the transaction (e.g., product data, transaction amount, payment details, etc.) into a point-of-sale device. In step 412, an authorization request may be generated and submitted by the merchant 108 (e.g., or an acquirer associated with the merchant 108) to a payment network 110 for processing.

A copy of the authorization request may be transmitted (e.g., by the payment network 110) to the processing server 102, which may be received by the processing server 102 in step 414. The authorization request may include at least a consumer identifier, a merchant identifier, and transaction data. In step 416, the processing server 102 may identify the consumer profile 210 associated with the consumer 104 based on the included consumer identifier corresponding to the consumer identifier included in the authorization request. In step 418, the processing server 102 may identify a merchant profile 214 associated with the merchant 108 based on the merchant identifier included in the authorization request.

In step 420, the processing server 102 may generate a score for the payment transaction using one or more scoring rules based on the transaction data and may update the corresponding team score in the merchant profile 214 using the generated score. In step 422, the processing server 102 may generate one or more notifications based on the generated and/or updated score, which may be transmitted to the consumer 104 and/or additional parties. In step 424, the consumer 104 may receive (e.g., via the mobile device 106) the notification of the scored payment transaction. In step 426, the merchant 108 may receive a notification of the updated team score. It will be apparent to persons having skill in the relevant art that step 426 may be an optional step. In some instances, the merchant 108 may find value in receiving updated team scores, such as for encouraging competition or registration by consumers and offering additional incentives to consumers. For example, the merchant 108 may receive regular score updates, leaderboards may be posted and available (e.g., via the application program) to the merchant 108 and/or consumers 104, etc.

### Graphical User Interface

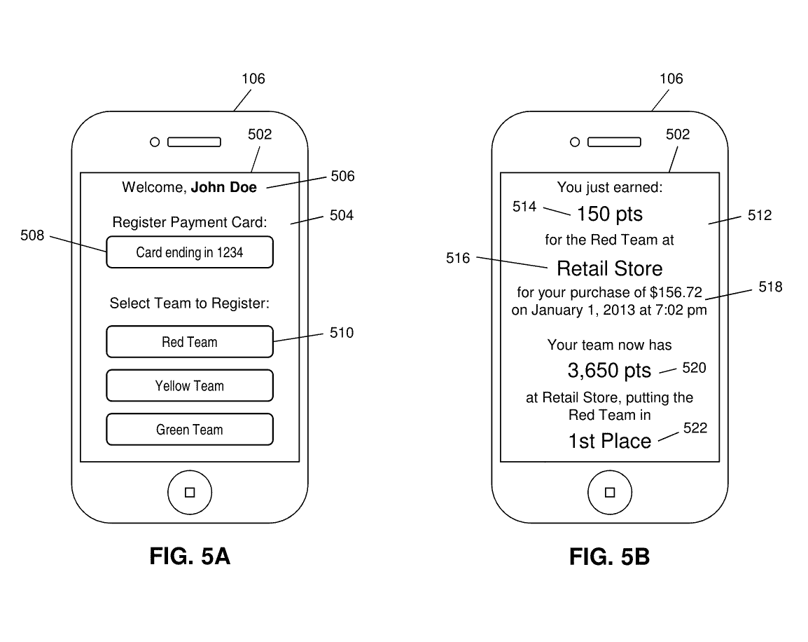

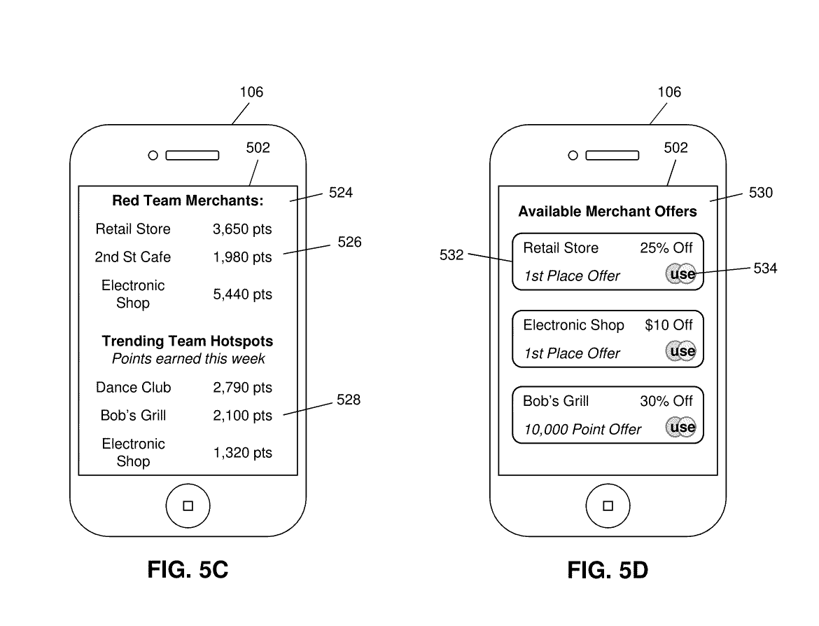

FIGS. 5A-5D illustrate an exemplary graphical user interface for the mobile device 106 of the consumer 104 for registering for the service with the processing server 102 and accessing exemplary features of the service. It will be apparent to persons having skill in the relevant art that the interface illustrated herein is provided as a means of illustration only, and that additional configurations, interfaces, and data included therein may be suitable.

As illustrated in FIG. 5A, the mobile device 106 may include a display 502. The display 502 may be configured to display a registration screen 504 of an application program executed by the mobile device 106. It will be apparent to persons having skill in the relevant art that the display of the interface via an application program executed by the mobile device 106 is illustrated and discussed herein, the interface may be displayed via additional methods and systems, such as via a webpage on a desktop computer, etc.

The registration screen 504 may include the name 506 of the consumer 104. The name 506 may be used to allow the consumer 104 to verify their identity, such that they do not inadvertently register a different person for the service while leaving themselves unregistered. The registration screen 504 may also include a payment account selection 508. The payment account selection 508 may be used by the consumer 104 to select a payment account to link with the service such that transactions funded by the selected payment account will be scored. The payment account selection 508 may be a text field, drop-down menu, radio button selection, or any other suitable selection method. In some embodiments, the registration screen 504 may include multiple payment account selections 508, such as for linking multiple payment accounts to the service.

The registration screen 504 may further include a team selection 510. The team selection 510 may provide the consumer 104 with a selection of teams to join when registering for the service. In addition to the team names as illustrated in FIG. 5A, the team selection 510 may further include descriptions of the team (e.g., common interests of members of the team, demographics of members of the team, etc.), a link to descriptions of the team, an indication of friends (e.g., of a social network, based on contact information in the mobile device 106, etc.) on a team, and other relevant information. In some embodiments, the registration screen 504 may also include capability for the consumer 104 to search for a team (e.g., by interest).

In the example interface illustrated in FIG. 5A, the team selection 510 may include a button for each respective team that may be selected. Once the consumer 104 selects the button for a team the consumer 104 desires to join, the mobile device 106 may submit the registration information, including the selected team and payment account, to the processing server 102. The processing server 102 may then store the information in a consumer profile 210 associated with the consumer 104.

When the consumer 104 conducts a valid payment transaction that is scored by the processing server 102, the consumer 104 may receive a notification of the successful transaction. As illustrated in FIG. 5B, the transaction notification may be displayed via a notification screen 512 displayed on the display 502 of the mobile device 106.

The notification screen 512 may include a point amount 514. The point amount 514 may refer to, or be based on, the score generated for the payment transaction by the processing server 102. The notification screen 512 may also include merchant data 516. The merchant data 516 may include information identifying the merchant 108 with whom the consumer 104 transacted, which may be used by the consumer 104 to verify the accuracy of the processing of the transaction score. The notification screen 512 may also include transaction data 518. The transaction data 518 may include, for example, a transaction amount and a time and date at which the transaction was conducted, as illustrated in FIG. 5B. In some embodiments, the consumer 104 may select the transaction data 518 to be displayed in the notification screen 512.

The notification screen 512 may further include a team score 520, which may represent the overall score of the team to which the consumer 104 belongs at the merchant 108 indicated in the merchant data 516. The notification screen 512 may also include a team rank 522. The team rank 522 may indicate the rank of the team of the consumer 104 at the merchant 108 as compared to the other teams. As illustrated in FIG. 5B, the Red Team, to which the consumer 104 belongs, is indicated to the consumer 104 as being in first place at Retail Store. It will be apparent to persons having skill in the relevant art that, in some embodiments, the notification screen 512 may also display an overall team score, an overall consumer score, a consumer score at the merchant 108, or other suitable type of score.

In some embodiments, the consumer 104 may be able to view additional data regarding their team when using the application program executed by the mobile device 106. As illustrated in FIG. 5C, the consumer 104 may access a team statistics screen 524, which may be used to convey various statistics associated with the team of the consumer 104 based on scored transactions.

The team statistics screen 524 may include a merchant listing 526. The merchant listing 526 may include all merchants 108 where the team of the consumer 104 is ranked first based on their corresponding team score. As illustrated in FIG. 5C, the Red Team, to which the consumer 104 belongs, may be in first place with three different merchants 108. The merchant listing 526 may also display the team score for each merchant 108 included in the merchant listing 526.

The team statistics screen 524 may further include a hotspot listing 528. The hotspot listing 528 may include merchants 108 that are trending with the team of the consumer 104. Trending merchants may be identified based on the score increase for the team at the respective merchant over a predetermined period of time. As illustrated in FIG. 5C, the hotspot listing 528 may include merchants 108 where the team has earned the most points during the current week. The hotspot listing 528 may be valuable to the consumer 104 to not only influence the consumer 104 to visit the listed merchants 108 in order to increase the team's ranking, but may also inform the consumer 104 of new merchants 108 that the consumer 104 may be interested in on a team where other team members have similar interests to the consumer 104.

In embodiments where the processing server 102 is configured to distribute offers to consumers 104 based on scores, the consumer 104 may also be able to view an available offer screen 530 using the mobile device 106. As illustrated in FIG. 5D, the available offer screen 530 may display one or more offers 532 that are available to the consumer 104 based on eligibility due to one or more scores. As illustrated, the consumer 104 may be eligible for offers at Retail Store and Electronic Shop for their team being in first place at the merchants, and may also be eligible for an offer at Bob's Grill because their team has a team score of over 10,000 points at the merchant.

Each offer 532 listing on the available offer screen 530 may also include an offer amount, such as the 25% off listed for the offer 532 at Retail Store illustrated in FIG. 5D. Each offer 532 may also include a use button 534. The use button 534, when interacted with by the consumer 104, may accept or otherwise activate the corresponding offer 532 for use by the consumer 104. Methods for accepting use of the offer may include notifying the merchant 108 for redemption of the offer when the consumer 104 transacts there, display of a machine-readable code on the display 502 for presentation to the merchant 108, display of an offer code to be entered by the consumer 104 at a merchant website, transmitting of a machine-readable code or offer code to the mobile device 106 via e-mail, short message service message, or other suitable method for presentation to the merchant 108, or other suitable method as will be apparent to persons having skill in the relevant art.

### Exemplary Method for Scoring a Payment Transaction

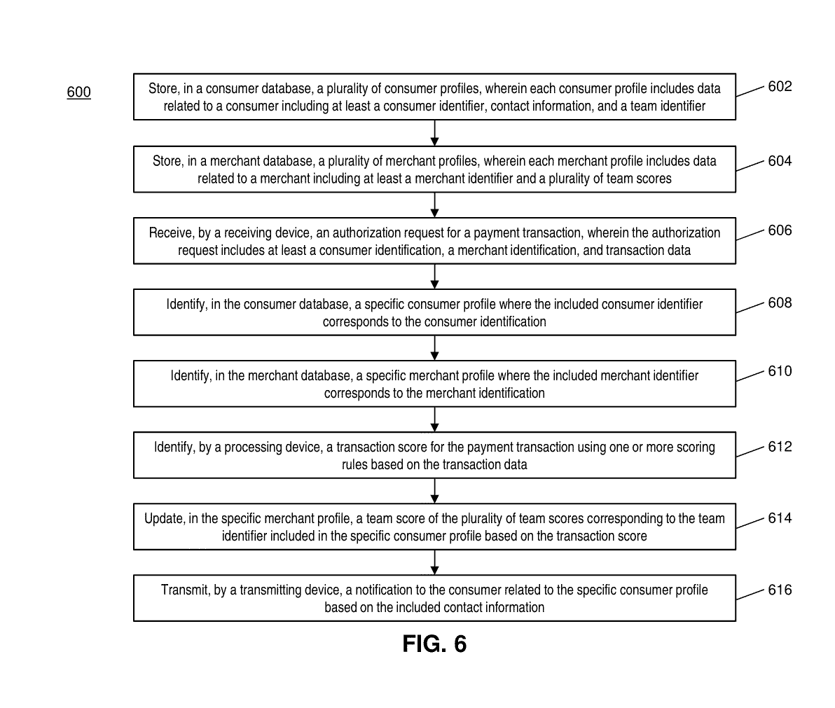

FIG. 6 illustrates a method 600 for scoring a payment transaction and subsequent updating of a team score at a corresponding merchant.

In step 602, a plurality of consumer profiles (e.g., the consumer profiles 210) may be stored in a consumer database (e.g., the consumer database 208), wherein each consumer profile 210 includes data related to a consumer (e.g., the consumer 104) including at least a consumer identifier, contact information, and a team identifier. In some embodiments, the contact information may include at least one of: an e-mail address, phone number, street address, media access control address, internet protocol address, name, and username. In one embodiment, the consumer identifier may be a payment account number associated with a payment account associated with the related consumer 104.

In step 604, a plurality of merchant profiles (e.g., the merchant profiles 214) may be stored in a merchant database (e.g., the merchant database 212), wherein each merchant profile 214 includes data related to a merchant (e.g., the merchant 108) including at least a merchant identifier and a plurality of team scores. In step 606, a receiving device (e.g., the receiving unit 202) may receive an authorization request for a payment transaction, wherein the authorization request includes at least a consumer identification, a merchant identification, and transaction data. In one embodiment, the transaction data may include at least one of: transaction amount, transaction time and/or date, payment method, payment information, product data, purchase order number, invoice number, and geographic location.

In step 608, a specific consumer profile 210 may be identified, in the consumer database 208, where the included consumer identifier corresponds to the consumer identification. In step 610, a specific merchant profile 214 may be identified, in the merchant database 212, where the included merchant identifier corresponds to the merchant identification. In step 612, a processing device (e.g., the processing unit 204) may identify a transaction score for the payment transaction using one or more scoring rules based on the transaction data. In step 614, a team score of the plurality of team scores corresponding to the team identifier included in the specific consumer profile 210 may be updated, in the specific merchant profile 214, based on the transaction score.

In step 616, a notification may be transmitted, by a transmitting device (e.g., the transmitting unit 206) to the consumer 104 related to the specific consumer profile 210 based on the included contact information. In one embodiment, the method 600 may further include: storing, in a team database (e.g., the team database 216), a plurality of team profiles (e.g., the team profiles 218), wherein each team profile 218 includes data related to a team of consumers including at least a team identification and a point total; identifying, in the team database 216, a specific team profile 218 where the included team identification corresponds to the team identifier included in the specific consumer profile 210; and updating, in the specific team profile 218, the point total based on the identified transaction score.

In another embodiment, the method 600 may further include: storing, in an offer database (e.g., the offer database 220), an offer data entry (e.g., the offer data entry 222) corresponding to an offer for the purchase of goods or services including at least the merchant identifier included in the specific merchant profile 214, offer data, and a target score; and transmitting, by the transmitting device 206, the offer data included in the offer data entry 222 to the consumer 104 related to the specific consumer profile 210 based on the included contact information if the updated team score is at least equal to the target score. In a further embodiment, the transmitting offer data may be included in the notification. In another further embodiment, the offer data may include at least one of: offer name, offer description, offer amount, offer type, offer category, merchant type, merchant category, manufacturer information, start date, expiration date, quantity, and limitations on redemption.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4A, 4B, and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive, the removable storage unit 718 may be a floppy disk. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3, 4A, 4B, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for scoring payment transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for scoring a payment transaction, comprising:
storing, in a consumer database, a plurality of consumer profiles, wherein each consumer profile includes data related to a consumer including at least a consumer identifier, contact information, and a team identifier;
storing, in a merchant database, a plurality of merchant profiles, wherein each merchant profile includes data related to a merchant including at least a merchant identifier and a plurality of team scores;
receiving, by a receiving device, an authorization request for a payment transaction, wherein the authorization request includes at least a consumer identification, a merchant identification, and transaction data;
identifying, in the consumer database, a specific consumer profile where the included consumer identifier corresponds to the consumer identification;
identifying, in the merchant database, a specific merchant profile where the included merchant identifier corresponds to the merchant identification;
identifying, by a processing device, a transaction score for the payment transaction using one or more scoring rules based on the transaction data;
updating, in the specific merchant profile, a team score of the plurality of team scores corresponding to the team identifier included in the specific consumer profile based on the transaction score; and
transmitting, by a transmitting device, a notification to the consumer related to the specific consumer profile based on the included contact information.

2. The method of claim 1, further comprising:
storing, in a team database, a plurality of team profiles, wherein each team profile includes data related to a team of consumers including at least a team identification and a point total;
identifying, in the team database, a specific team profile where the included team identification corresponds to the team identifier included in the specific consumer profile; and
updating, in the specific team profile, the point total based on the identified transaction score.

3. The method of claim 1, further comprising:
storing, in an offer database, an offer data entry corresponding to an offer for the purchase of goods or services including at least the merchant identifier included in the specific merchant profile, offer data, and a target score; and
transmitting, by the transmitting device, the offer data included in the offer data entry to the consumer related to the specific consumer profile based on the included contact information if the updated team score is at least equal to the target score.

4. The method of claim 3, wherein the transmitted offer data is included in the notification.

5. The method of claim 3, wherein the offer data includes at least one of:
offer name, offer description, offer amount, offer type, offer category, merchant type, merchant category, manufacturer information, start date, expiration date, quantity, and limitations on redemption.

6. The method of claim 1, wherein the transaction data includes at least one of: transaction amount, transaction time and/or date, payment method, payment information, product data, purchase order number, invoice number, and geographic location.

7. The method of claim 1, wherein the contact information includes at least one of: an e-mail address, phone number, street address, media access control address, internet protocol address, name, and username.

8. The method of claim 1, wherein the consumer identifier is a payment account number associated with a payment account associated with the related consumer.

9. A system for scoring a payment transaction, comprising:
a consumer database configured to store a plurality of consumer profiles, wherein each consumer profile includes data related to a consumer including at least a consumer identifier, contact information, and a team identifier;
a merchant database configured to store a plurality of merchant profiles, wherein each merchant profile includes data related to a merchant including at least a merchant identifier and a plurality of team scores;
a receiving device configured to receive an authorization request for a payment transaction, wherein the authorization request includes at least a consumer identification, a merchant identification, and transaction data;
a processing device configured to
identify, in the consumer database, a specific consumer profile where the included consumer identifier corresponds to the consumer identification,
identify, in the merchant database, a specific merchant profile where the included merchant identifier corresponds to the merchant identification,
identify a transaction score for the payment transaction using one or more scoring rules based on the transaction data, and
update, in the specific merchant profile, a team score of the plurality of team scores corresponding to the team identifier included in the specific consumer profile based on the transaction score; and
a transmitting device configured to transmit a notification to the consumer related to the specific consumer profile based on the included contact information.

10. The system of claim 9, further comprising:
a team database configured to store a plurality of team profiles, wherein each team profile includes data related to a team of consumers including at least a team identification and a point total, wherein
the processing device is further configured to
identify, in the team database, a specific team profile where the included team identification corresponds to the team identifier included in the specific consumer profile, and
update, in the specific team profile, the point total based on the identified transaction score.

11. The system of claim 9, further comprising:
an offer database configured to store an offer data entry corresponding to an offer for the purchase of goods or services including at least the merchant identifier included in the specific merchant profile, offer data, and a target score, wherein
the transmitting device is further configured to transmit the offer data included in the offer data entry to the consumer related to the specific consumer profile based on the included contact information if the updated team score is at least equal to the target score.

12. The system of claim 11, wherein the transmitted offer data is included in the notification.

13. The system of claim 11, wherein the offer data includes at least one of: offer name, offer description, offer amount, offer type, offer category, merchant type, merchant category, manufacturer information, start date, expiration date, quantity, and limitations on redemption.

14. The system of claim 9, wherein the transaction data includes at least one of: transaction amount, transaction time and/or date, payment method, payment information, product data, purchase order number, invoice number, and geographic location.

15. The system of claim 9, wherein the contact information includes at least one of: an e-mail address, phone number, street address, media access control address, internet protocol address, name, and username.

16. The system of claim 9, wherein the consumer identifier is a payment account number associated with a payment account associated with the related consumer.
